(19) United States
(12) Patent Application Publication
(10) Pub. No.: US 2021/0177185 A1
(43) Pub. Date: Jun. 17, 2021

(54) VERTICAL PIPE CLAMP COUPLER

(71) Applicant: Philip DiTrolio, Suwanee, GA (US)

(72) Inventor: Philip DiTrolio, Suwanee, GA (US)

(21) Appl. No.: 17/188,118

(22) Filed: Mar. 1, 2021

Related U.S. Application Data
(63) Continuation-in-part of application No. 15/727,695, filed on Oct. 9, 2017, now Pat. No. 10,941,560.
Application No. 15/727,695 is a continuation-in-part of application No. 29/739,477, filed on Jun. 25, 2020.
(60) Provisional application No. 62/417,121, filed on Nov. 3, 2016.
(60) Provisional application No. 62/984,182, filed on Mar. 2, 2020.

(51) Int. Cl. A47H 1/102; F16B 2/10

(52) U.S. Cl. CPC A47H 1/102; F16B 2/10

(57) ABSTRACT

The pipe-mounted clamp coupler enables the industry standard hooks on horizontal rods and other accessories to rest at such a height as to provide uniform appearance to the top of drape walls. The clamp coupler is configured with a hinged body that is closable around the pipe and secured with a screw tightener. The clamp coupler includes a connection bridge that supports a coupler to receive accessories. The accessories may include a castletop coupler that is either affixed to the connection bridge or mounts on the coupler affixed to the connection bridge. The pipe-mounted clamp coupler allows multiple horizontal rods to be mounted in parallel from a single vertical pipe via one or more couplers.

### CROSS-REFERENCE TO RELATED APPLICATIONS

This application is a continuation-in-part of and claims priority to U.S. application Ser. No. 15/727,695, filed Oct. 9, 2017, and entitled “Connector for Pipes” which claims priority to U.S. Provisional Patent Application No. 62/417,121, filed Nov. 3, 2016, and entitled “Coupler for Pipes.” This application also claims priority to U.S. Provisional Application No. 62/984,182, filed Mar. 2, 2020, and entitled “Vertical Pipe Clamp Coupler.” This application is also a continuation-in-part of and claims priority to U.S. Design Application No. 29/739,477 filed Jun. 25, 2020 and entitled “Connector Accessory for Pipes.” The entire contents of the above-identified applications are hereby fully incorporated herein by reference.

### FIELD OF INVENTION

The present invention relates to couplers for drape rods of the type typically found in exhibit booths. In even greater particularity, the present invention relates to a clamp coupler adaptor to affix to an end of a vertical pipe to allow accessories for drape rods to be mounted.

### BACKGROUND

In the prior art, exhibit booths and the like are constructed using a tubular framework supporting drapes as walls and or covers. Many of these booths are constructed using a hook-and-slot system, which utilize upright aluminum poles with slots formed near the top regions thereof for receiving hooks secured to and extending from the ends of horizontal tubular rods. Draping material is placed over the horizontal rods to form booths or partitions as may be required. Pipe and drape walls traditionally have a bumpy appearance due to the height difference of the vertical members in relation to the top of horizontally disposed connecting rods. Additionally, the steel hooks on industry standard horizontal drape rods have a tendency to “tear” the aluminum vertical uprights in a “can opener” effect when the steel hooks are inserted in the existing slots in the uprights.

### SUMMARY OF THE INVENTION

The present pipe-mounted clamp coupler enables the industry standard hooks on horizontal rods and other accessories to rest at such a height as to provide uniform appearance to the top of drape walls. A further object is to allow a clamp coupler adaptor to mount on a pipe or rod vertical end to allow one or more accessory connections to be affixed to the vertical pipe. The clamp coupler is configured with a hinged body that is closable around the pipe and secured with a screw tightener. The clamp coupler includes a connection bridge that supports a coupler to receive accessories. The accessories may include a castletop coupler that is either affixed to the connection bridge or mounts on the coupler affixed to the connection bridge. A further object is to allow multiple horizontal rods to be mounted in parallel from a single vertical pipe via one or more couplers.

The pipe-mounted clamp coupler prevents the steel hooks on industry standard horizontal drape rods from “tearing” into the support pipes. The pipe-mounted coupler allows accessories for the industry standard hooks to be inserted at a wider angle of insertion and to allow easier connection as compared to the narrow industry standard slots. The pipe-mounted coupler accomplishes the foregoing benefits using industry standard fasteners or hooks.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

Referring to the drawings, which are appended hereto and which form a portion of this disclosure, it may be seen that:

FIG. 1 is a perspective view of one embodiment of a clamp coupler.

FIG. 2 is a side plan view of one embodiment of the clamp coupler.

FIG. 3 is a top plan view of one embodiment of the clamp coupler.

FIG. 4 is a perspective view of one embodiment of the clamp coupler.

FIG. 5 is a perspective view of one embodiment of the clamp coupler mounted on a vertical pipe.

FIG. 6 is a perspective view of one embodiment of the clamp coupler mounted on a vertical pipe.

### DETAILED DESCRIPTION

The example embodiments described herein provide a clamp coupler 40 that supports a coupler 10 for connecting substantially orthogonally disposed rods to vertical support pipes in a pipe and drape exhibit booth construction. The “Pipe and Drape” industry, is a subset of exhibition and convention services in which frameworks are constructed from horizontally and vertically disposed members in such a fashion to allow draperies or curtains to hang and create division of space in convention halls or other similar areas by arranging drapery walls and booths. The coupler 10 is designed to provide an improvement to form and function over the industry standard hook and slot technology, yet allowing users of existing systems to continue using their inventory of components.

The clamp coupler 40 allows accessories, such as coupler 10, to be affixed to the end of the vertical pipe. The accessories may include a castletop coupler that is either affixed to the connection bridge or mounts on the coupler affixed to the connection bridge. The accessories might allow a coupler 10 to be affixed to the clamp coupler 40 in an offset position. The accessories might allow a second and third coupler be affixed to the first coupler 10 in offset positions to allow additional rods to be vertically supported. The clamp coupler 40 allows additional rods to be connected to the top of a single vertical pipe or wall mounted coupler 10. In examples herein, when one coupler 10 is being described, other examples that include two or more couplers 10 in any configuration may be envisioned to operate substantially similarly.

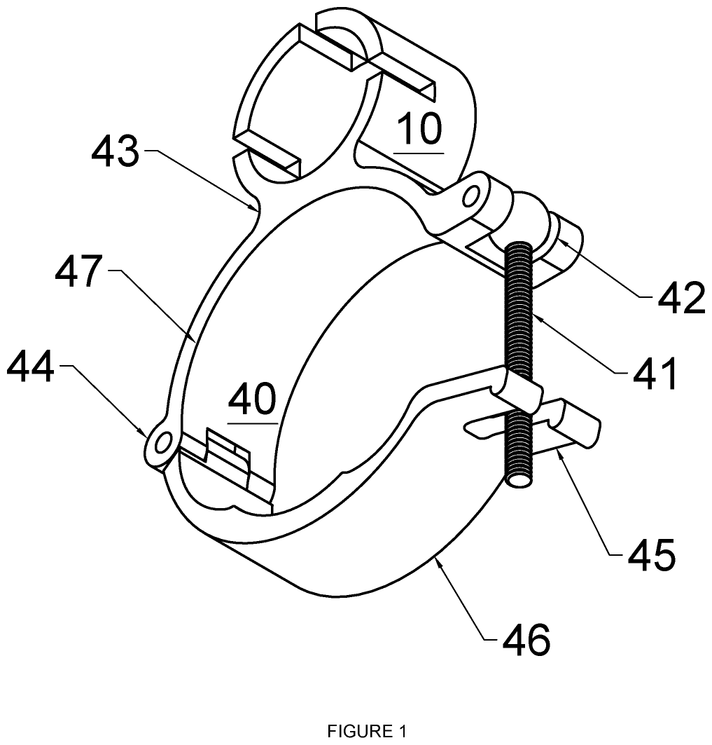

FIG. 1 provides a perspective view of the clamp coupler 40, which is used to construct the aforesaid pipe and drape booths. Because the steel terminal hooks traditionally used on the transverse rods to connect to the vertical member are used to connect to the instant coupler 10 or other attached accessory, the steel hooks are not illustrated. The clamp coupler 40 includes features such as a screw tightener 41, a screw connection 42, a connection bridge 43, a clamp hinge 44, a screw receiver 45, a clamp body 46 and 47, and an accessory, such as coupler 10. Preferably, clamp coupler 40 will be made from durable reinforced polymer material, ABS plastic, Delrin, polyurethane, or some other suitable material that has sufficient strength and rigidity to effectuate the connection.

The clamp coupler 40 fits onto a vertically configured pipe, rod, tube, or other member. The pipe fits within the circular body of clamp coupler 40 because the inner diameter of the clamp coupler 40 when loosely fastened is greater than the outer diameter of the pipe. In an example, the clamp coupler 40 opens via the clamp hinge 44 in a clamshell manner. The clamp coupler 40 is placed around the pipe with the clamp hinge 44 open to allow the two portions of the clamp body 46, 47 of the clamp coupler 40 to encircle the pipe. The vertically positioned pipe may be any suitable size, such as 2 inch, 3 inch, or 4 inch pipe. The vertically positioned pipe may be any suitable type of metal or plastic pipe, tube, or other similarly cylindrical member.

The clamp body portions 46, 47 are closed via the clamp hinge 44 around the pipe circumference. In an example, the clamp coupler 40 closes via the clamp hinge 44 in the manner of a closing clamshell device. In an alternate embodiment, the clamp body portions 46, 47 do not employ a clamp hinge 44 to open and close around a pipe. In an alternate example, the clamp body 46, 47 is flexible such that the clamp body 46, 47 may be flexed open to allow the clamp coupler 40 be placed around the pipe. In another example, the clamp body 46, 47 is configured of two pieces with connectors in two positions. For example, screw type fasteners are on two opposing sides of the clamp coupler 40. In another example, two different types of connectors are on two opposing sides of the clamp coupler 40, such as screw type fastener on one side and a clip fastener on the opposing side.

In an example, the screw tightener 41 is affixed to the screw connection 42 with a rotatable connection. That is, the screw tightener 41 may be swung open and away from the screw receiver 45 to allow the clamp coupler 40 to be placed around the pipe and then closed when the clamp coupler 40 is around the pipe.

After the clamp body portions 46, 47 are closed via the clamp hinge 44 around the pipe circumference, the screw tightener 41 is rotated to allow the end of the screw tightener 41 opposite the screw connection 42 to be placed into the screw receiver 45. Any suitable means of engaging the screw tightener 41 may be used. For example, a wingnut may be placed on the screw tightener 41 and turned to cause the screw tightener 41 to tighten the clamp coupler 40. In another example, a nut is threaded onto the screw tightener 41. In another example, the screw tightener 41 threads onto threads embedded in the screw receiver 45. That is, the screw tightener 41 spins freely into stationary threads of the screw receiver 45. In another example, the screw tightener 41 is not a threaded screw, but is instead a different type of locking or tightening fastener.

As the screw tightener 41 is tightened, the clamp body portions 46, 47 are drawn together to reduce the circumference of the clamp coupler 40. As the circumference is reduced, the clamp coupler 40 tightens around the pipe. When the clamp coupler 40 is sufficiently tight around the pipe, the clamp coupler 40 becomes affixed in the position on the pipe based on the friction created by the compression of the clamp coupler 40 on the pipe.

In an example, one or both of the clamp body portions 46, 47 has a contoured, scalloped inner perimeter as depicted in clamp body portion 46 in FIG. 1. The one or more scallops of the contour allow the clamp coupler 40 to be affixed to multiple pipe diameters. The scalloped inner perimeter allows the clamp body portions 46, 47 to get a firm “bite” on the pipe despite variations in the diameter of the pipe. The degree of curvature of each scalloped portion may vary based on the sizes of pipes that are likely to be encountered. For example, if a fewer number of sizes are likely to be encountered, such as only 2 or 3 inch pipes, then a fewer number of scallops may be required, scallops with a larger radius of curvature may be required, or both. If a greater number of sizes are likely to be encountered, such as only 2, 2.5, 3, or 4 inch pipes, then a greater number of scallops may be required, scallops with a smaller radius of curvature may be required, or both. In another example, one or both of the clamp body portions 46, 47 may be constructed of a material that allows a small amount of flex. That is the clamp body portions 46, 47 are stiff enough to provide a firm support for affixed rods but are pliable enough to bend around differently sized pipes when compressed.

In examples, the connection bridge 43 and the coupler 10 may be mounted to either clamp body portion 46 or clamp body portion 47 such that the coupler 10 is positioned vertically to receive steel hooks or other connectors for drapes and rods. The connection bridge 43 connects the coupler to a portion of the clamp coupler 40. The coupler 10 may be any suitable connector for drapes and rods, such as the castletop coupler. In another example, a castletop coupler mounts on the coupler 10 affixed to the connection bridge 43. Any other suitable coupler may be either mounted to the connection bridge 43 or mounted onto the coupler 10.

The connection bridge 43 may be of various lengths to allow the desired positioning of the coupler 10 with respect to the pipe. For example, the connection bridge 43 is illustrated as being of a minimal length such that the coupler 10 is adjacent to the clamp body portion 47, but the connection bridge 43 may alternatively be 1, 2, or 3 inches long or any other suitable length depending on how far the coupler 10 should be from the clamp body portion 47. In another example, the coupler 10 may be mounted at a different angle from the vertical angle depicted. For example, if the pipe to which the clamp coupler 40 is mounted is horizontal instead of vertical, then the coupler 10 may be rotated 90 degrees on the connection bridge 43 such that the coupler 10 is facing upwards even though the clamp coupler 40 is facing horizontally. Any other angle may be used, such as 30 or 45 degrees from vertical.

In an alternate embodiment, two or more couplers 10 may be mounted on the clamp coupler 40. For example, one coupler 10 is mounted to a connection bridge 43 affixed to clamp body portion 46, and a second coupler 10 is mounted to a connection bridge 43 affixed to clamp body portion 47. By having a coupler 10 on both sides of the clamp coupler 40, the embodiment allows drapes and rods to be affixed to both sides of the pipe. Any other types of coupler, connector, or accessory may be affixed to the clamp coupler 40 to allow drapes and rods and other hanging booth paraphernalia to be supported by the pipe.

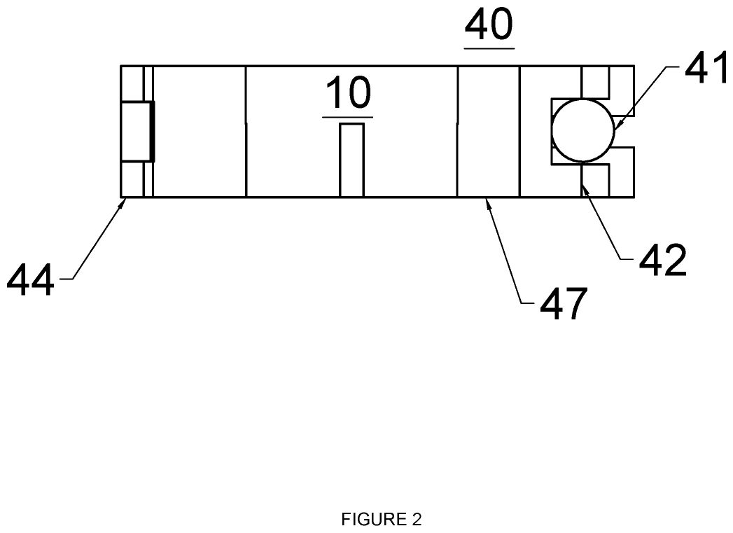

FIG. 2 is a side view of one embodiment of the clamp coupler 40. The illustration includes the clamp coupler 40 and features such as a screw tightener 41, a screw connection 42, a clamp hinge 44, a clamp body 47, and an accessory, such as coupler 10 as described with reference to FIG. 1. The clamp coupler 40 is illustrated as being closed with the screw tightener 41 being rotated to allow the end of the screw tightener 41 opposite the screw connection 42 to be placed into the screw receiver 45.

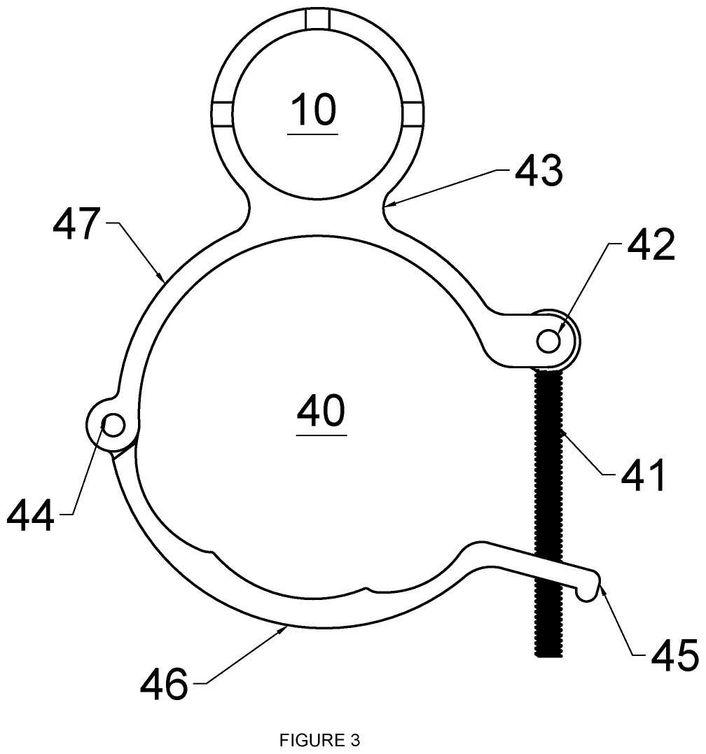

FIG. 3 is a top view of one embodiment of the clamp coupler 40. The illustration includes a screw tightener 41, a screw connection 42, a connection bridge 43, a clamp hinge 44, a screw receiver 45, a clamp body 46 and 47, and an accessory, such as coupler 10, as described with reference to FIG. 1. The clamp coupler 40 is illustrated as being closed with the screw tightener 41 being rotated to allow the end of the screw tightener 41 opposite the screw connection 42 to be placed into the screw receiver 45. From this position, the screw tightener 41 may be tightened to reduce the circumference of the clamp coupler 40 to match the circumference of the pipe.

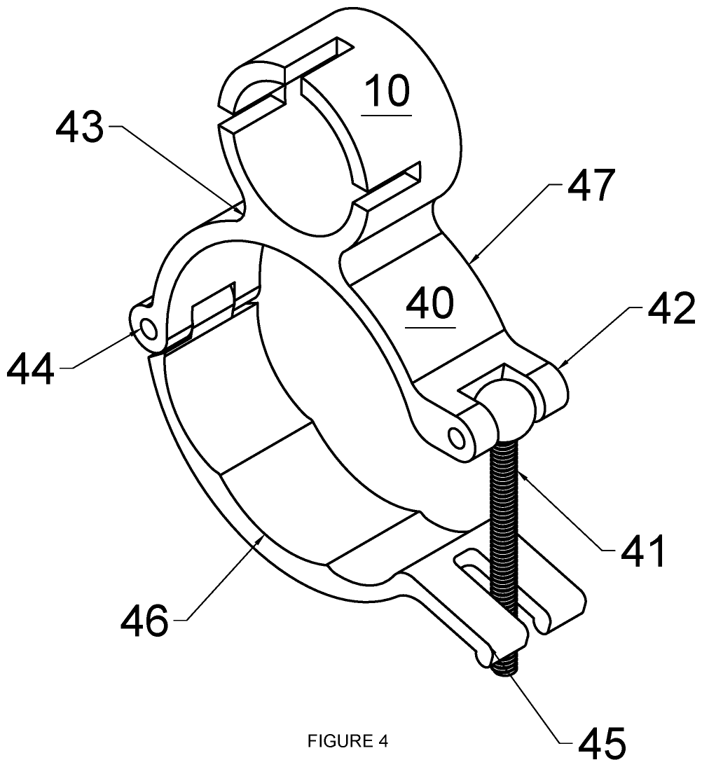

FIG. 4 is a perspective view of one embodiment of the clamp coupler 40. The illustration includes a screw tightener 41, a screw connection 42, a connection bridge 43, a clamp hinge 44, a screw receiver 45, a clamp body 46 and 47, and an accessory, such as coupler 10, as described with reference to FIG. 1. The clamp coupler 40 is illustrated as being closed with the screw tightener 41 being rotated to allow the end of the screw tightener 41 opposite the screw connection 42 to be placed into the screw receiver 45. From this position, the screw tightener 41 may be tightened to reduce the circumference of the clamp coupler 40 to match the circumference of the pipe.

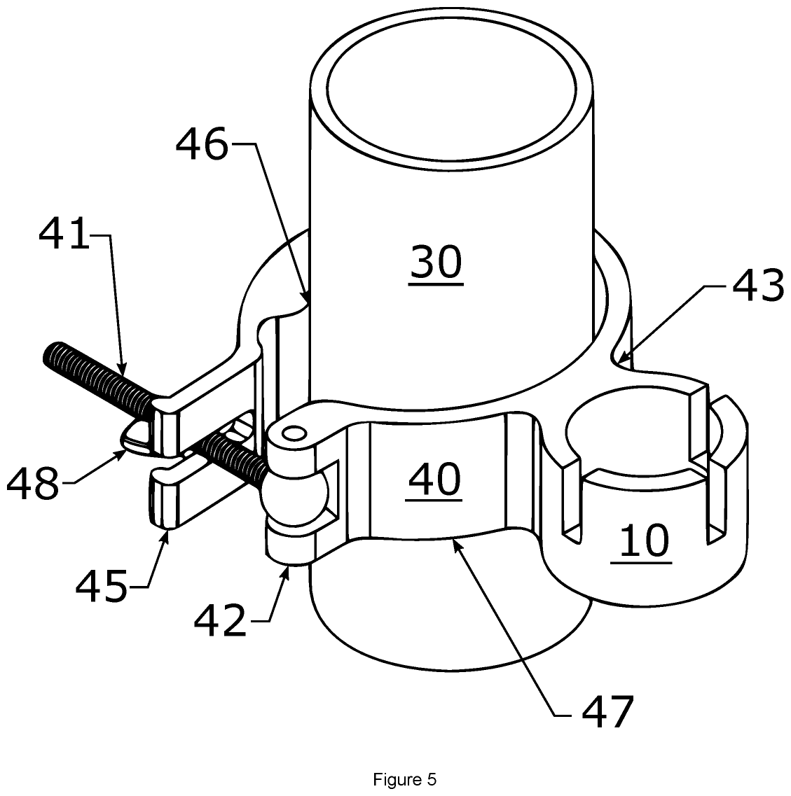

FIG. 5 is a perspective view of one embodiment of the clamp coupler 40 mounted on a vertical pipe 30. The illustration includes a screw tightener 41, a screw connection 42, a connection bridge 43, a screw receiver 45, a clamp body 46 and 47, and an accessory, such as coupler 10. The clamp coupler 40 is illustrated as being closed around the vertical pipe 30. The screw tightener 41 is rotated to allow the end of the screw tightener 41 opposite the screw connection 42 to be placed into the screw receiver 45. From this position, the screw tightener 41 may be tightened to reduce the circumference of the clamp coupler 40 to match the circumference of the pipe 30. The screw tightener 41 is illustrated with a wingnut 48. The wingnut 48 screws onto the screw tightener 41 and forces the clamp body 46 and the clamp body 47 together to close around the vertical pipe 30. Other devices may be used to tighten the screw tightener 41 as described herein. The scallops on the clamp body 46 are shown as being pressed into the vertical pipe 30 and creating a friction connection to secure the clamp coupler 40 to the vertical pipe 30.

As illustrated, the screw receiver 45 and the screw connection 42 do not meet when the clamp coupler 40 is tightened around the pipe 30. Because the clamp coupler 40 is able to create a secure friction connection to the vertical pipe 30 without closing completely together, different sized vertical pipes 30 may be used. For example, if the vertical pipe 30 were smaller, then the screw receiver 45 and the screw connection 42 would be closer together when tightened. If the vertical pipe 30 were larger, then the screw receiver 45 and the screw connection 42 would be farther apart when tightened. As the screw tightener 41 is long enough to tighten the clamp coupler 40 over a range of distances and due to the scalloped interior, the clamp coupler 40 is usable over a variety of pipe sizes.

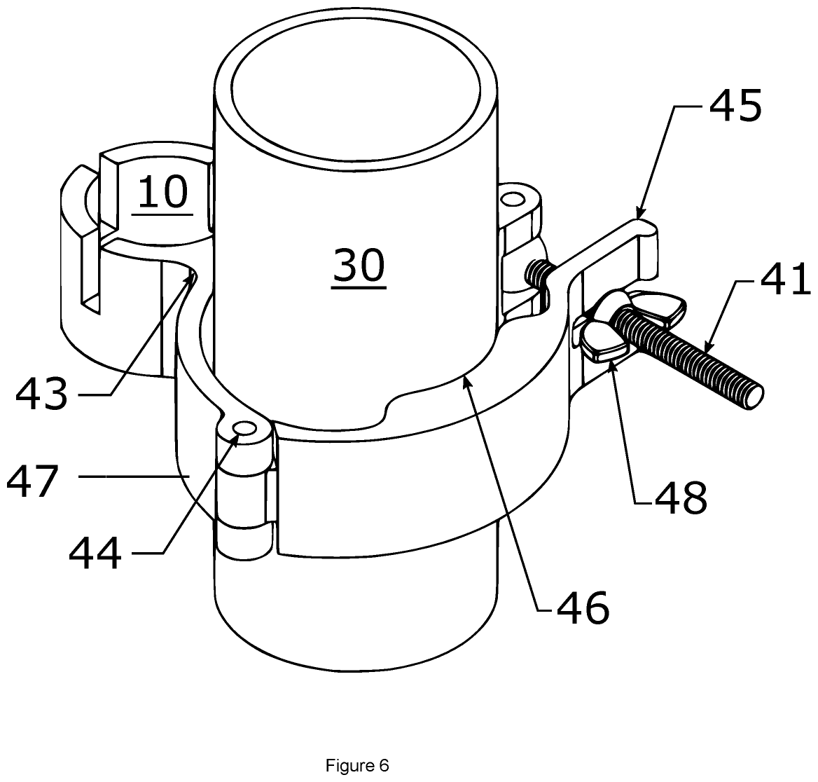

FIG. 6 is a perspective view of one embodiment of the clamp coupler 40 mounted on a vertical pipe 30. The illustration includes a screw tightener 41, a connection bridge 43, a screw receiver 45, a clamp body 46 and 47, a clamp hinge 44 and an accessory, such as coupler 10. The clamp coupler 40 is illustrated as being closed around the vertical pipe 30. The screw tightener 41 is rotated to allow the end of the screw tightener 41 opposite the screw connection 42 to be placed into the screw receiver 45. From this position, the screw tightener 41 may be tightened to reduce the circumference of the clamp coupler 40 to match the circumference of the vertical pipe 30. The screw tightener 41 is illustrated with a wingnut 48. The wingnut 48 screws onto the screw tightener 41 and forces the clamp body 46 and the clamp body 47 together to close around the vertical pipe 30. Other devices may be used to tighten the screw tightener 41 as described herein. The scallops on the clamp body 46 are shown as being pressed into the vertical pipe 30 and creating a friction connection to secure the clamp coupler 40 to the vertical pipe 30.

What is claimed is:

1. A clamp coupler to mount to vertical pipes, comprising:
a clamp coupler to support accessories to a substantially cylindrical pipe, the clamp coupler comprising a hinged body that is closable around the cylindrical pipe, a screw connection, a screw tightener, and a connection bridge that supports a coupler to receive accessories.

2. The clamp coupler of claim 1, wherein the accessories are industry standard hangers.

3. The clamp coupler of claim 1, wherein the accessories comprise one or more additional couplers to receive terminal connectors connected to drape rods.

4. The clamp coupler of claim 1, wherein the screw tightener receives a threaded connection to tighten the clamp coupler.

6. The clamp coupler of claim 1, wherein an interior surface of a portion of the hinged body is scalloped.

7. The clamp coupler of claim 1, wherein the screw connection is connected to the hinged body by a hinged connection.

8. The clamp coupler of claim 1, wherein the clamp coupler comprises a plurality of connection bridges that supports a plurality of couplers to receive accessories.

9. The clamp coupler of claim 1, wherein the cylindrical pipe is vertically positioned.

10. The clamp coupler of claim 1, wherein a screw receiver has threads to receive the screw tightener to tighten the clamp coupler around the cylindrical pipe.

11. The clamp coupler of claim 1, wherein the screw tightener mates with a threaded nut to tighten the clamp coupler around the cylindrical pipe.

12. A method to couple rods, comprising:
affixing a clamp coupler to support accessories to a vertical-positioned, substantially cylindrical pipe, the claim coupler comprising a hinged body that is closable around the pipe, a screw connection, a screw tightener, and a connection bridge that supports a coupler to receive accessories.

13. The method of claim 12, wherein the screw tightener receives a threaded connection to tighten the clamp coupler.

14. The method of claim 12, wherein an interior circumference of a portion of the hinged body is scalloped.

15. The method of claim 12, wherein the screw connection is connected to the hinged body by a hinged connection.

16. The method of claim 12, wherein the clamp coupler comprises a plurality of connection bridges that supports a plurality of couplers to receive accessories.
